(19) United States
(12) Patent Application Publication
(10) Pub. No.: US 2010/0308713 A1
(43) Pub. Date: Dec. 9, 2010

(54) AT LEAST SINGLE-LAYER INORGANIC THICK-FILM AC ELECTROLUMINESCENCE SYSTEM HAVING DIFFERENTLY CONTOURED AND LARGELY TRANSPARENT CONDUCTIVE LAYERS, METHOD FOR THE PRODUCTION THEREOF, AND USE THEREOF

(75) Inventors: Thomas Wagner, Hasselroth (DE); Michael Heite, Olpe (DE); Thilo-josef Werners, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/739,444

(22) PCT Filed: Oct. 24, 2008
(86) PCT No.: PCT/EP2008/064428

§ 371 Date: Apr. 23, 2010

(30) Foreign Application Priority Data
Oct. 25, 2007 (DE) 102007000569.7
Dec. 11, 2007 (DE) 102007055762.2

(51) Int. Cl. H01J 1/62; H01J 9/02

(52) U.S. Cl. 313/503; 445/58

(57) ABSTRACT

The invention relates to an at least single-layer flat EL luminous system based on at least one inorganic thick-film AC-electroluminescent (EL) element having at least two electrically conducting flat electrodes, wherein at least one of the two flat electrodes is largely transparent and the at least two electrodes have a graphically configured contour and an EL emission takes place only in those regions in which two corresponding electrodes overlap and an EL layer is arranged between two corresponding electrodes and the EL emission in the overlapping electrode regions has a different emission colour and, by operating the at least one EL element with at least one alternating voltage, an EL luminous system corresponding to the graphical configuration of the at least two flat electrodes is thus obtained.

A process for the production of an at least single-layer flat EL luminous system is further described, and its use as a lamp, as an advertising object, as an artistic structure and the like is mentioned

The invention relates to a flat (planar) electroluminescent (EL) luminous system based on at least one inorganic thick-film AC-electroluminescent (EL) element, to a process for its production and to its use. The electroluminescent (EL) system according to the invention is distinguished in particular by the fact that an electroluminescent (EL) emission takes place only in those regions in which the electrodes used in the element overlap.

By arranging at least two EL elements in a layer sequence and providing the EL emission regions, almost arbitrarily, in at least two different planes, and owing to the possibility of providing different colours for the EL emission or of combining the EL emission with translucent elements, colour-converting elements or graphical layer-like structures, a large number of aesthetic effects and animation effects can be achieved. The substantially true-to-life reproduction of animal fur, for example, is thereby possible. In addition, the at least two EL elements can be operated with time-variable brightness values and with overlapping luminous regions, so that flowing water, for example, can be represented in that manner.

EP 1 026 923 B1 discloses an electroluminescent lamp for emitting light in a plurality of colours from a front surface side of a transparent substrate. The structure of the lamp provided therein starts from a first light-permeable electrode layer on the back side of the substrate, to which there are applied a first luminous material layer and an intermediate light-permeable electrode layer and a second luminous material layer and a back electrode layer. Also disclosed are some colour materials which produce a corresponding colouration according to their arrangement in the various layers, the colour material closer to the back electrode of the at least two elements having a colour of longer wavelength than the remoter colour material.

Accordingly, that publication discloses a multi-colour and multi-layer EL lamp system which has light-permeable electrode layers covering its entire surface but does not exhibit electroluminescence emission that is discontinuous, that is to say interrupted, in places.

The object of the present invention is to provide an electroluminescent system in which an electroluminescence emission preferably takes place only in specific previously defined or specifiable regions, that is to say in particular not over the entire surface, the surrounding area being partially transparent.

The object is achieved by an at least single-layer electroluminescent (EL) luminous system based on at least one inorganic thick-film AC electroluminescent element (EL element).

The at least one EL element used in the at least single-layer electroluminescent (EL) luminous system according to the invention has at least two electrically conducting flat electrodes, the electrode surfaces being so arranged relative to one another that the electrode surfaces do not overlap completely. As a result, EL emission takes place only in those regions in which the two corresponding electrode surface elements overlap.

Within the scope of the present invention, the electrodes used in the EL elements can be graphically configured.

Within the scope of the present invention, incomplete overlapping of the electrodes is understood as meaning that, in general, from 1 to 99%, preferably from 5 to 90%, particularly preferably from 10 to 85%, especially from 15 to 80%, specifically from 20 to 70%, of the at least two corresponding electrodes overlap.

Within the scope of this invention, any combination of two electrode surface elements, which include at least one electroluminescent layer and optionally an insulating layer (dielectric layer), can be used as the electroluminescent capacitor for producing luminous effects (electroluminescent (EL) arrangement). If the EL arrangement has been applied to a substrate and provided with a protective layer or film, it is referred to as an electroluminescent (EL) element.

In order to achieve a so-called “floating electrode”, that is to say an electrode that is not potential-bound, two electrodes are connected to alternating voltage in such a manner that they are oppositely charged, whereby the electrodes preferably do not overlap completely. The electrodes are arranged in one plane or in different planes and are made to interact with a third or further electrode located above, between or beneath them. Between the electrodes there is arranged an electroluminescent layer or a plurality of electroluminescent layers, so that luminous effects can be produced.

The various electrodes can be operated in various combinations of galvanic coupling or separation. A “floating electrode” is thereby operated by galvanic separation from the two electrodes connected to alternating voltage.

The electroluminescent luminous system according to the invention can comprise one or more EL elements. If the electroluminescent luminous system according to the invention comprises one EL element, then it is referred to as single-layer, that is to say one electroluminescent element in the electroluminescent luminous system is defined within the scope of the present invention as one layer. If a plurality of electroluminescent elements are provided in the electroluminescent luminous system according to the invention, then the electroluminescent luminous system is correspondingly referred to as multi-layer.

The remaining structure of the electroluminescent system according to the invention corresponds to the structure of conventional systems known from the prior art.

An EL layer is therefore generally arranged between two corresponding electrodes of an electroluminescent arrangement, the EL emissions—as already explained—taking place only in the overlapping electrode regions. The emission colour can be single- or multi-colour depending on the structure of the pigment layer.

In addition, the electroluminescent system can be changed and configured by the graphical configuration of at least one of the at least two electrodes that are required per electroluminescent element.

Accordingly, when the at least one EL element is operated with at least one alternating voltage, an electroluminescence emission corresponding to the graphical configuration of the flat electrodes is achieved by the EL system according to the invention. Furthermore, different dynamic luminous effects can be achieved by applying alternating voltages that vary in terms of voltage level and, optionally, frequency. Such luminous effects are particularly pronounced when the electroluminescent system according to the invention has at least two electroluminescent elements which can be operated independently of one another.

The present invention further provides a process for the production of such multi-layer flat EL luminous systems according to the invention by means of screen printing. In a particular embodiment, the EL luminous system is subjected in the process according to the invention to three-dimensional shaping, for example by insertion into an injection-moulding tool to form a 3D-EL luminous system, for example having an integrally moulded thermoplastic plastics moulding.

The present invention further provides the use of the EL system according to the invention as a lamp, as an advertising object, as an artistic structure and the like.

Some exemplary embodiments of the invention are described in detail hereinbelow with reference to the drawings. It is to be noted that the comments made in the description of the figures can also be applied to systems in which a different number of electroluminescent elements than that indicated in the exemplary embodiments can be present in the electroluminescent luminous system according to the invention. Likewise, the features mentioned hereinbefore and hereinafter can be used according to the invention individually or in any desired combinations with one another. The mentioned exemplary embodiments are not to be interpreted as limiting and are of exemplary nature.

The comments made in relation to the figures refer to electroluminescent systems which generally comprise the following functional layers, it also being possible for individual functional layers to be omitted in some embodiments:
a) a transparent or non-transparent rear electrode as component BE;
b) a first insulating layer as component BD;
c) a layer, comprising at least one luminous substance that can be excited by an electrical field, as component BC;
d) optionally a further insulating layer as component BB; and
e) an at least partially transparent cover electrode (=front electrode) as component BA.

Accordingly, the electroluminescent systems provided according to the invention are generally based on an inorganic thick-film AC element, which can be produced, for example, using conventional flat-bed and cylinder screen printing machines. The electroluminescent system according to the invention can therefore be produced in a simple manner using conventional and available devices.

### IN THE FIGURES

FIG. 1: shows a diagrammatic section of an example of an EL system (1) according to the invention based on at least one inorganic thick-film AC-electroluminescent (EL) element (2, 3),

FIG. 2: shows a diagrammatic top view of an EL luminous element (2, 3, 34) according to the invention having the luminous fields (36, 37),

FIG. 3: shows a diagrammatic top view of the contoured front electrode (42) of an EL luminous system according to the invention, and

FIG. 4: shows a diagrammatic top view of the contoured rear electrode (43) of an EL luminous system according to the invention.

### DESCRIPTION OF THE FIGURES

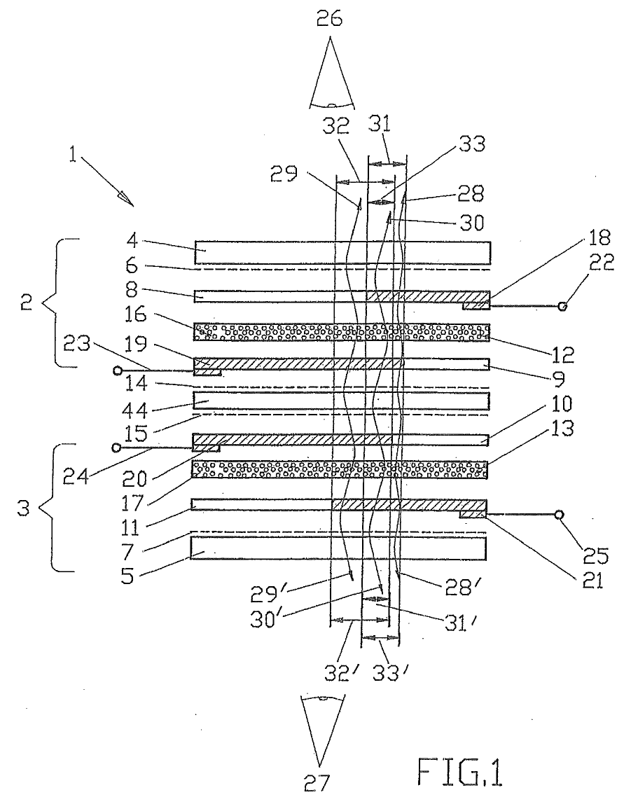

FIG. 1 shows a diagrammatic section of an example of an EL luminous system (1) according to the invention based on at least two inorganic thick-film AC-electroluminescent (EL) elements (2, 3). The EL luminous system according to the invention can generally comprise any number of inorganic thick-film AC-electroluminescent (EL) elements and is not limited to the presence of two electroluminescent elements as shown by way of example in FIG. 1.

According to the invention, preferably from 1 to 4, particularly preferably from 1 to 2 or 3, EL elements are used in the electroluminescent luminous system, because the layer structure is complex and the luminous effect becomes less favourable as the number of layers and electroluminescent elements increases, because the individual electrode layers and EL layers do not provide 100% permeability to light. However, the fundamental principle can be extended according to the invention to any number of EL elements. Between the individual electroluminescent elements there can be arranged an insulating layer, which is identified in FIG. 1 by reference numeral (44) between the two electroluminescent elements (2) and (3). In addition, it is also possible to omit the insulating layer (44) if the contours of the second electrode (23) and third electrode (24) are identical, that is to say if the second and third electrodes coincide, i.e. form a single electrode. This fundamental structure can also apply to one or more subsequent layers, that is to say the immediately adjacent electrodes of immediately adjacent EL elements can form a single electrode.

The fundamental principle of such an EL luminous system (1) can be designed with a light emission in both directions, that is to say upwards (28, 29, 30) and thus visible to an upper observer (26), and downwards (28′, 29′, 30′) and thus visible to a lower observer (27). However, it can also be designed to emit on only one side, for example in the direction towards the upper observer (26) or in the direction towards the lower observer (27), and in this case the lower electrode and/or the lower insulating layer can be non-transparently opaque (electroluminescence emission visible to the upper observer (26)) or the upper electrode and/or the upper insulating layer can be non-transparently opaque (electroluminescence emission visible to the lower observer (27)).

In this diagrammatic section of FIG. 1, only one EL emission region 1 (31, 31′) of the upper EL element 1 (2) and one EL emission region 2 (32, 32′) of the lower EL element 2 (3) is shown for the sake of simplicity. Furthermore, the representation has been so chosen that the two EL emission regions (31, 31′, 32, 32′) exhibit an overlapping region (33, 33′). This choice of the individual emission regions has been chosen at random in this figure, however, and can be changed as desired within the scope of the present invention.

The emission colours are determined by the choice of EL pigments (EL phosphors, electroluminophores) (16, 17) in the EL layers (12, 13). The electroluminescent pigments used in one of the electroluminescent layers generally have a thickness of from 1 to 50 μm, preferably from 5 to 25 μm.

Thick-film AC-EL elements frequently comprise zinc disulfide electroluminophores, but these experience a very high degradation specifically at elevated temperatures and in a water vapour atmosphere. For that reason, microencapsulated EL pigments are generally used for long-life thick-film AC-electroluminescent elements. It is also possible, however, to use non-microencapsulated pigments in the EL elements of the present invention, as is explained further hereinbelow.

Electroluminescent Layers

The following comments apply to the electroluminescent layers of all the electroluminescent elements used in the electroluminescent system according to the invention, it being possible for the individual electroluminescent layers to be identical or different.

The electroluminescent element used according to the invention comprises at least one electroluminescent layer as the layer BC. The layer BC can also be formed from a plurality of layers having an electroluminescent effect.

The at least one electroluminescent layer BC is generally arranged between the cover electrode (component BA), or optionally a dielectric layer (component BB), and the dielectric layer (component BD). The electroluminescent layer can be arranged immediately adjacent to the dielectric layers BB and BD, or one or more further layers can optionally be arranged between the dielectric layers BB and BD and the electroluminescent layer BC. The electroluminescent layer BC is preferably arranged immediately adjacent to the dielectric layers BB and BD.

The at least one electroluminescent layer can be arranged on the entire inner surface of the cover electrode (component BA) or insulating layer (component BD) or on one or more partial surfaces of the cover electrode. In the case where the electroluminescent layer is not closed but is arranged on a plurality of partial surfaces, for example of the cover electrode, the partial surfaces generally have a mutual interspacing of from 0.5 to 500 mm, preferably from 0.5 to 50.0 mm, particularly preferably from 1 to 5 mm.

It is additionally possible in the electroluminescent elements used according to the invention for the electroluminescent layer to consist of two or more electroluminescent layer elements arranged next to one another and having different EL pigments, so that different colours can be produced by the EL element.

The electroluminescent layer is generally composed of a binder matrix with EL pigments homogeneously dispersed therein. The binder matrix is generally chosen so as to produce a good adhesive bonding to the cover electrode layer (component BA) or to the dielectric layer (component BB) and the dielectric layer (component BD). In a preferred embodiment, systems based on PVB or PU are thereby used. In addition to the electroluminescent pigments, further additives can optionally also be present in the binder matrix, such as colour-converting organic and/or inorganic systems, colorant additives for a day- and night-time light effect and/or reflecting and/or light-absorbing effect pigments, such as aluminium flakes, glass flakes or mica platelets. In general, the proportion of electroluminescent pigments in the total mass of the electroluminescent layer (degree of filling) is from 20 to 75 wt. %, preferably from 50 to 70 wt. %.

The electroluminescent pigments used in the electroluminescent layer generally have a thickness of from 1 to 50 μm, preferably from 5 to 25 μm.

Thick-film AC-EL elements have been known since Destriau in 1947 and are applied to ITO-PET films mostly by means of screen printing. Since zinc sulfide electroluminophores experience a very high degradation in operation, specifically at elevated temperatures and in a water vapour atmosphere, microencapsulated EL pigments are nowadays generally used for long-life thick-film AC-EL lamp structures. It is, however, also possible to use non-microencapsulated pigments in the electroluminescent element used according to the invention, as is discussed further hereinbelow.

Suitable electroluminescent screen printing pastes are generally formulated on the basis of inorganic substances. Suitable substances are, for example, highly pure ZnS, CdS, ZnₓCd₁₋ₓS compounds of groups IIB and IV of the Periodic System of the Elements, ZnS being particularly preferably used. The above-mentioned substances can be doped or activated and optionally also co-activated. Copper and/or manganese, for example, are used for the doping. The co-activation is carried out, for example, with chlorine, bromine, iodine and aluminium. The content of alkali metals and rare earth metals in the above-mentioned substances is generally very low, if these are present at all. Most particular preference is given to the use of ZnS, which is preferably doped or activated with copper and/or manganese and is preferably co-activated with chlorine, bromine, iodine and/or aluminium.

Normal electroluminescence emission colours are yellow, green, green-blue, blue-green and white, the emission colours white or red being able to be produced by mixtures of suitable EL pigments or by colour conversion. The colour conversion can generally be implemented in the form of a converting layer and/or by admixture of appropriate dyes and pigments in the polymeric binder of the screen printing inks or in the polymeric matrix in which the electroluminescent pigments are incorporated.

The screen printing matrix used for the production of the electroluminescent layer is generally provided with glazing, colour-filtering or colour-converting dyes and/or pigments. The emission colour white or a day/night light effect can be generated in this manner.

In a further embodiment, the pigments used in the electroluminescent layer have an emission in the blue wavelength range from 420 to 480 nm and are optionally provided with a colour-converting microencapsulation. The colour white can likewise be emitted in this manner.

In addition, the AC-P-EL screen printing matrix preferably contains wavelength-converting inorganic fine particles based on europium(II)-activated alkaline earth orthosilicate silicate phosphors, such as (Ba, Sr, Ca)₂SiO₄:Eu²⁺, or YAG YAG phosphors, such as Y₃Al₅O₁₂:Ce³⁺, or Tb₃Al₅O₁₂:Ce³⁺, or Sr₂GaS₄:Eu²⁺, or SrS:Eu²⁺, or (Y,Lu,Gd,Tb)₃(Al,Sc,Ga)₅O₁₂:Ce³⁺ or (Zn,Ca,Sr)(S,Se):Eu²⁺. A white emission can also be achieved in this manner.

Corresponding to the prior art, the above-mentioned EL pigments can be microencapsulated. Good half-life times can be achieved by the inorganic microencapsulation techniques. The electroluminescent screen printing system Luxprint® for EL from E.I. du Pont de Nemours and Companies may be mentioned here by way of example. Organic microencapsulation techniques and film-wrap laminates based on the various thermoplastic films are in principle also suitable.

Suitable zinc sulfide microencapsulated EL pigments are supplied by Osram Sylvania, Inc. Towanda under the trade names GlacierGLO® Standard, High Brite® and Long Life®, and by the Durel Division of the Rogers Corporation under the trade names 1PHS001® High-Efficiency Green Encapsulated EL Phosphor, 1PHS002® High-Efficiency Blue-Green Encapsulated EL Phosphor, 1PHS003® Long-Life Blue Encapsulated EL Phosphor and 1PHS004® Long-Life Orange Encapsulated EL Phosphor.

The mean particle diameters of the microencapsulated pigments used in the electroluminescent layer are generally from 15 to 60 μm, preferably from 20 to 35 μm.

As already mentioned, non-microencapsulated fine grain electroluminescent pigments, preferably with a high service life, can also be Used in the electroluminescent layer of the electroluminescent element used according to the invention. Suitable non-microencapsulated fine grain zinc sulfide electroluminescent phosphors are disclosed, for example, in U.S. Pat. No. 6,248,261 and in WO 01/34723, the corresponding disclosure of which is incorporated by way of reference in the present invention. These preferably have a cubic crystal lattice structure. The non-micro encapsulated pigments preferably have mean particle diameters of from 1 to 30 um, particularly preferably from 2 to 15 μm, most particularly preferably from 5 to 10 μm.

Specifically, non-microencapsulated electroluminescent pigments with smaller pigment dimensions down to below 10 μm can be used.

Thus, unencapsulated pigments can be admixed with the starting materials used according to the present invention for the electroluminescent layer, such as, for example, the screen printing inks, preferably having regard to the special hygroscopic properties of the pigments, preferably the ZnS pigments. In this connection there are generally used binders that on the one hand have a good adhesion to so-called ITO layers (indium-tin oxide) or to intrinsically conducting polymeric transparent layers, and that on the other hand have a good insulating effect, strengthen the dielectric and thereby effect an improvement of the breakdown strength at high electric field strengths, and in addition in the cured state exhibit a good water vapour barrier and additionally protect the phosphor pigments and prolong the service life.

The half-life times of the suitable pigments in the electroluminescent layer, i.e. the time during which the initial brightness of the electroluminescent element used according to the invention has fallen by half, are in general at 100 volts and 80 volts and 400 hertz, from 400 hours to 7000 hours.

The brightness values (electroluminescence emission) are in general from 1 to 200 cd/m², particularly preferably from 1 to 100 cd/m², especially in the range from 5 to 70 cd/m².

Pigments with longer or shorter half-life times and higher or lower brightness values can, however, also be used in the electroluminescent layer of the electroluminescent element which is used in the electroluminescent arrangement according to the invention.

In a further embodiment of the present invention the pigments present in the electroluminescent layer have such a small mean particle diameter, or such a low degree of filling in the electroluminescent layer, or the individual electroluminescent layers are configured geometrically so small, or the interspacing of the individual electroluminescent layers is chosen so large, that the electroluminescent element in the case of non-electrically activated luminous structures is configured to be at least partially transparent or to ensure transmissibility. Suitable pigment particle diameters, degrees of filling, dimensions of the luminous elements and interspacings of the luminous elements have been mentioned hereinbefore.

In a further embodiment of the present invention the electroluminescent layer contains pigments of different colours. In this case, the electroluminescent layer contains preferably two, particularly preferably three, especially four, specifically five, more specifically six, pigments of different colours. The pigment layer can be multi-colour as a result. The differently coloured pigments can be so arranged in the electroluminescent layer that differently coloured surfaces, contours and/or structures are formed in that layer.

In a further, particularly preferred embodiment, the electroluminescent layer in the electroluminescent element is based on an EL pigment emitting the colour green and colour conversion pigments dispersed homogeneously in the electroluminescent layer. Suitable colour conversion pigments for this purpose are, for example, “EL Color Converting Pigments FA-000 Series” from Sinloihi Co., Ltd., Japan. It is also possible to admix a colour-converting substance, such as rhodamine, so that a white emission is achieved.

By using at least two electroluminescent elements in an electroluminescent system it is moreover possible to produce a luminous field that differs locally and in wavelength by choosing at least two electroluminescent layers arranged next to one another and having different EL pigments. A luminous field that differs locally and in wavelength can be achieved in that manner.

In a further embodiment of the present invention, the electroluminescent layer is itself contoured and/or structured. It is thereby possible for the electroluminescent layer not to be filled with pigment in the entire layer plane. The regions of the electroluminescent layer that are not filled with pigment can thereby be filled with transparent, opaque and/or non-transparent insulating material to form a closed layer. The regions filled with transparent, opaque and/or non-transparent insulating material can in turn be contoured and/or structured.

When the electroluminescent luminous system according to the invention comprises more than two electroluminescent elements, it is preferred according to the invention that the regions of the electroluminescent layer that are filled with pigment do not overlap or overlap only partially.

When the electroluminescent luminous system according to the invention comprises more than two electroluminescent elements, it is additionally preferred according to the invention that regions of two or more electroluminescent elements, in particular regions filled with different material, coincide or at least overlap. Thus, for example, regions in one layer that are filled with pigment of a particular colour can overlap with regions in another layer that are filled with pigment of a different colour and/or with transparent, opaque and/or non-transparent insulating material.

In a further, particularly preferred embodiment, the electroluminescent layer in the electroluminescent element is based on an EL pigment emitting the colour green and colour conversion pigments dispersed homogeneously in the electroluminescent layer. Suitable colour conversion pigments for this purpose are, for example, “EL Color Converting Pigments FA-000 Series” from Sinloihi Co., Ltd., Japan. It is also possible to admix a colour-converting substance, such as rhodamine, so that a white emission is achieved. Furthermore, colour-converting substances can be admixed with the polymeric binder matrix. It is thereby possible to achieve wavelength displacements by a few 10 to approximately 100 nm in the terms of a Stokes displacement. Furthermore, colour-filtering, glazing or translucent graphical layers (6, 7, 14, 15) can be used to configure the emission colours. These graphical printed layers (6, 7, 14, 15) can also have masking opaque properties or reflecting or semi-reflecting properties. Day-night effects can additionally be generated by such printed layers (6, 7, 14, 15). Furthermore, luminescent organic substances and inorganic pigments can be used in such printed layers.

The electroluminescent system according to the invention is operated by an electroluminescence voltage supply with an alternating voltage frequency in the range from 200 Hz to over 1000 Hz.

As already mentioned, it is advantageous for the electroluminescent luminous system according to the invention if the electroluminescent system is in flexible form. The electroluminescent layer is therefore preferably produced by screen printing techniques because this results in good flexibility and foldability of the resulting electroluminescent layer. A polymeric resilient binder matrix, preferably based on polyurethane and most preferably in a two-component form, is thereby used. The zinc sulfide EL pigments are then dispersed in that binder polymer.

The electroluminescent system provided according to the invention and based on zinc sulfide thick-film alternating current alternating current-electroluminescence is accordingly an electroluminescent system that is particularly suitable for the required flexibility or formability.

Insulating Layer or Dielectric Layer

The following comments apply to the insulating layers (dielectric layers) of all the electroluminescent elements used in the electroluminescent system according to the invention, it being possible for the individual insulating layers to be identical or different.

In terms of production, the insulating layer (4) or the insulating layer (5) can be used in the form of a printing substrate film. In an alternative embodiment according to the invention, an insulating layer can also be inserted or applied as an intermediate film by lamination; as a result, the manufacturing process can be simplified and/or the three-dimensional formability of the resulting electroluminescent luminous system according to the invention can be improved.

Hereinbelow, the insulating layers (4, 5) are described in the form of transparent films as the printing substrate. Of course, within the scope of the present invention, when the electroluminescent luminous system according to the invention comprises more than two electroluminescent elements, it can also comprise more than only the two insulating layers (4, 5). The description of the insulating layer given hereinbelow then also applies to all further insulating layers.

The insulating film (4, 5), for single use or multiple use, is employed in sheet form or in roll form with a thickness of generally from 5 μm to 2 mm, preferably with a thickness of from 20 μm to 500 μm, particularly preferably with a thickness of from 70 μm to 250 μm, most particularly preferably with a thickness of from 75 μm to 175 μm. The insulating film (4, 5) is preferably transparent and can have high-gloss, matt, satin and/or textured surfaces. The surface of the insulating layer (4, 5) facing the observer (26, 27) can additionally be antireflective or provided with a so-called “hard coat” coating. In addition, it can in principle additionally be used in graphically printed form. The film materials used are usually polycarbonate (PC), PET, PET-G, PMMA, PVC or PVF (Tedlar®) or any desired blends of the above-mentioned polymers.

The film (4) should moreover exhibit adequate temperature stability without excessive shrinkage, because an elevated temperature has a substantial effect on the drying time during the drying of the individual layers. In addition, it is also possible to use pre-tempered films (4), in which the shrinkage problem in respect of the exact positioning of the individual printed layers is substantially reduced.

The film (4) can be provided on the underside with a graphical configuration in terms of masking, glazing or translucent layers.

Corresponding dielectric layers can also be obtained from dielectrically acting powders, such as, for example, barium titanate, which are preferably dispersed in fluorine-containing plastics or in cyano-based resins. Examples of particularly suitable particles are barium titanate particles in the range of preferably from 1.0 to 2.0 μm. With a high degree of filling these can produce a relative dielectric constant of up to 100.

The dielectric layer in the case of dielectrically acting powders has a thickness of generally from 1 to 50 μm, preferably from 2 to 40 μm, particularly preferably from 5 to 25 μm, specifically from 8 to 20 μm.

Within the scope of the present invention this layer is also preferably in flexible and foldable form. This is achieved, for example, by a polyurethane-based screen printing ink and most particularly by a two-component PU screen printing ink, it being possible to add barium titanate (BaTiO₃) pigments of the above-mentioned type in order to increase the relative dielectric constant. A relative dielectric constant of from 30 to 200 can be achieved in that manner. Because the admixture of BaTiO₃ effects an opaque whitish layer, this layer can also be used for reflecting the electroluminescence emission. If downward electroluminescence emission is required in addition to the upward electroluminescence emission, no BaTiO₃ should be added. The dielectric layer can also be in duplicate or multiple form because, specifically in screen printing, the incorporation of microbubbles cannot be avoided and this problem can be solved with duplicate screen printing.

The following comments apply to the electrodes of all the electroluminescent elements used in the electroluminescent arrangement according to the invention, it being possible for the individual electrodes to be identical or different.

The electrode (8) is preferably arranged by means of screen printing and can be graphically contoured. The other electrodes used within the scope of the present invention are generally also applied by means of screen printing and can likewise be graphically contoured. The materials used for the electrodes are described in detail hereinbelow:

Suitable electrically conducting materials for the electrodes are known to the person skilled in the art. In principle several types of electrodes are available for the production of thick-film EL elements with alternating voltage excitation. These include on the one hand indium-tin oxide electrodes (indium-tin oxides, ITO) applied in vacuo by sputtering or vapour deposition to plastics films. They are extremely thin (a few 100 Å) and have the advantage of a high transparency combined with a relatively low sheet resistance (ca. 60 to 600Ω).

Furthermore printing pastes with ITO or ATO (antimony-tin oxide) or intrinsically conducting transparent polymer pastes can be used, from which flat electrodes are produced by means of screen printing. At a thickness of ca. from 5 to 20 μm, such electrodes have only a relatively low transparency with a high sheet resistance (up to 50 kΩ). They can be applied largely as desired, and indeed also to structured surfaces. In addition they have a relatively good laminability. Also, non-ITO screen printing layers (wherein the term “non-ITO” includes all screen printing layers that are not based on indium-tin oxide (ITO)), in other words intrinsically conducting polymeric layers with normally nanoscale electrically conducting pigments, for example the ATO printing pastes with the designations 7162E or 7164 from DuPont, the intrinsically conducting polymer systems, such as the Orgacon® system from Agfa, the Baytron® poly-(3,4-ethylenedioxythiophene) system from H.C. Starck GmbH, the Ormecon® system termed organic metal (PEDT-conductive polymer polyethylene-dioxythiophene), conducting coating or printing ink systems from Panipol® OY and optionally with highly flexible binders, for example based on PU (polyurethanes), PMMA (polymethyl methacrylate), PVA (polyvinyl alcohol), or modified polyaniline, can be used. Preferably the Baytron® poly-(3,4-ethylenedioxythiophene) system from H.C. Starck GmbH is used as the material of the electrodes, in particular as the material of the at least partially transparent electrode. Examples of electrically conducting polymer films are polyanilines, polythiophenes, polyacetylenes, polypyrroles (Handbook of Conducting Polymers, 1986), with and without a metal oxide filling.

Moreover, tin oxide (MESA) pastes can also be used as corresponding electrode material.

It is also possible for the electrically conducting coating to be a metallic or metal oxide, thin and largely transparent layer produced in vacuo or pyrolytically, which preferably has a sheet resistance of less than 5 kΩ/square, more preferably from 5 mΩ/square to 3000 Ω/square, particularly preferably a sheet resistance of from 0.1 to 1000 Ω/square, most particularly preferably from 5 to 30 Ω/square, and in a further preferred embodiment has a transparency of at least greater than 60% (>60 to 100%) and in particular greater than 76% (>76 to 100%). It should be also mentioned in this connection that the sheet resistance in the case of small EL luminous arrangements (1) can be chosen relatively great and should be chosen correspondingly smaller in the case of large EL luminous arrangements (1). A high sheet resistance can often be compensated for by an optimal arrangement of the respective busbars (18) to (21) of the electrodes.

Within the scope of the present invention, however, preference is given to the use of intrinsically conducting polymers as the electrode material, in particular of the above-described type. The sheet resistance of corresponding electrodes of intrinsically conducting polymers should generally be less than 5 kΩ/square, preferably from 100 to 2000 Ω/square, particularly preferably from 200 to 1500 Ω/square, in particular from 200 to 1000 Ω/square, specifically from 300 to 600 Ω/square.

It is also possible to use combinations of the mentioned variants.

The electrode materials can be applied, for example, by means of screen printing, knife coating, spraying, brushing to corresponding carrier materials (substrates), by means of vacuum or pyrolytically to corresponding carrier materials (substrates), which are then preferably dried at low temperatures of for example, from 80 to 120° C.

The rear electrode (component BE)—like the at least partially transparent cover electrode (component BA)—is a flat electrode which, however, does not need to be transparent or at least partially transparent. It is generally composed of electrically conducting materials based on inorganic or organic substances, for example of metals such as silver. Suitable electrodes are also in particular polymeric electrically conducting coatings. The coatings already mentioned above in connection with the at least partially transparent cover electrode can be used. In addition, it is possible to use polymeric, electrically conducting coatings known to the person skilled in the art that are not at least partially transparent.

Suitable materials for the rear electrode are accordingly preferably selected from the group consisting of metals such as silver, carbon, ITO screen printing layers, ATO screen printing layers, non-ITO screen printing layers, that is to say intrinsically conducting polymeric systems containing usually nano-scale electrically conducting pigments, for example ATO screen printing pastes with the designation 7162E or 7164 from DuPont, intrinsically conducting polymer systems such as the Orgacon® system from Agfa, the Clevios® poly-(3,4-ethylenedioxythiophene) system from H. C. Starck GmbH, the system from Ormecon referred to as organic metal (PEDT conductive polymer polyethylene-dioxythiophene), conducting coating and printing ink systems from Panipol Oy and optionally with highly flexible binders, for example based on PU (polyurethanes), PMMA (polymethyl methacrylate), PVA (polyvinyl alcohol) or modified polyaniline, it being possible in order to improve the electrical conductivity for the above-mentioned materials to have metals such as silver or carbon added to them and/or to be supplemented with a layer of those materials.

It is additionally possible in a first embodiment for the cover electrode (component BA) to comprise particles with nano-structures.

It is also possible in a second embodiment for the rear electrode (component BE) to comprise particles with nano-structures.

In a third embodiment, both the cover electrode and the rear electrode comprise particles with nano-structures.

Within the scope of the present invention the expression “particles with nanostructures” is understood as meaning nano-scale material structures that are selected from the group consisting of single-wall carbon nanotubes (SWCNTs), multi-wall carbon nanotubes (MWCNTs), nanohorns, nanodisks, nanocones (i.e. structures with conically shaped jackets), metallic nanowires and combinations of the above-mentioned particles. Corresponding particles with nanostructures based on carbon can, for example, consist of carbon nanotubes (single-wall and multi-wall), carbon nanofibres (herringbone, platelet-type, screw-type) and the like.

The production of these single-walled carbon nanotubes is known to the person skilled in the art and reference can be made to corresponding processes in the prior art. These include, for example, catalytic chemical gaseous phase deposition CCVD.

These processes often produce fractions that differ as regards their diameter, length, chirality and electronic properties. Within the scope of the present invention there are preferably used fraction-pure single-walled carbon nanotubes, that is to say fractions of single-walled carbon nanotubes that differ in terms of a parameter selected from the group consisting of diameter, length, chirality and electronic properties by not more than 50%, particularly preferably by not more than 40%, especially by not more than 30%, specifically by not more than 20% and most specifically by not more than 10%.

With regard to metallic nanowires, reference is made to WO 2007/022226 A2, the disclosure of which regarding the nanowires disclosed therein is incorporated by way of reference in the present invention. The electrically highly conducting and largely transparent silver nanowires described in WO 2007/022226 A2 are particularly suitable for the present invention.

The production of the other particles with nanostructures is known to the person skilled in the art and is described in the corresponding documents of the prior art.

With regard to the flexibility of the electroluminescent element according to the invention that is preferably to be achieved for the present invention, it is particularly preferred for the partially transparent electrically conducting flat cover electrode and/or the rear electrode to be constructed on the basis of an intrinsically conducting polymer, for example Clevios® P from H.C. Starck. Substances that increase the electrical conductivity and the formability, such as nano-scale particles based on SWCNTs or silver nanowires, or nanocones or nanotubes, can be added, as a result of which the transparency is not substantially affected. Busbar systems are conventionally arranged especially in the contact region of the two flat electrodes, and the electrical contacts can thus be produced with a low contact resistance by means of crimping, piercing, clamping or electrically conducting bonding.

Busbars

The following comments apply to the busbars of all the electroluminescent elements used in the electroluminescent system according to the invention, it being possible for the individual busbars to be identical or different.

The busbars (18) to (21) used to supply power to the electrodes are likewise preferably produced by screen printing with the respective electrical connections (22) to (25). The corresponding busbars can be formed by highly conducting printable pastes. These pastes can, for example, be opaque silver pastes, copper pastes or carbon pastes. The corresponding pastes can also comprise particles with nanostructures within the scope of the present invention. Corresponding printing pastes are substantially not subject to any restriction as regards the sheet resistance. Normally, however, they have a sheet resistance in the range from below 10 mΩ/square to a few 100 mΩ/square.

Especially with large surface areas and interspacings and relatively high-resistive transparent electrode layers, it is suitable to use busbars for a uniform EL emission.

The electrical connections (22) to (25) are so chosen that optimal contacting is possible depending on the type of use. In the case of the use of the EL luminous system (1) according to the invention in the form of a film, edge positions are normally advantageous for the connections, and conventional crimp connections or clamp connections or connections with an electrically conducting adhesive can then be used. In the case of the use of the EL luminous system (1) according to the invention in the form of an inserted injection-moulded element, the EL connections (22) to (25) can be provided in virtually any desired position, the EL emission regions (31, 32, 33) preferably not being chosen as the position for the connections.

The EL layers 1 and 2 (12 and 13) with the EL pigments (16 and 17) largely homogeneously dispersed in a suitable polymeric binder matrix are likewise preferably applied by means of screen printing. The same is also true for further electroluminescent layers if present within the scope of the present invention.

In the diagrammatic section shown in FIG. 1, only the EL layer (12) is shown without an additional dielectric layer. This is achieved in the present case by a special EL layer (12) which at the same time has insulating properties. However, the present invention also includes EL luminous systems in which a slightly thinner EL layer (12) is printed and one or more, preferably two, dielectric layers are additionally used, those dielectric layers preferably being transparent in the present case. In both cases, an EL layer (12) that is as transparent or translucent as possible should be chosen. This can be achieved as already described or by using slightly finer grain EL pigments (16). Microencapsulated EL pigments (16) having a d₅₀ in the range from 25 to 30 μm are normally used. In the present case, EL pigments (16) having a d₅₀ of from 5 μm to 17 μm offer good translucence while providing adequate EL emission (28, 28′). Alternatively, it is also possible to reduce the degree of filling of EL pigments to below 70 wt. %, for example. The use of corresponding electroluminescent pigments having the previously defined d₅₀ values or degrees of filling can also be expedient for the other electroluminescent layers, so that corresponding transparency, if desired, is achieved.

As an alternative to the use of finer grain EL pigments (16) or to the use of a lower degree of filling of below 70 wt. %, it is also possible to configure the EL layer (12) pointwise. The individual EL pigment points can thereby have a geometrically exact shape, such as a circle, an ellipse, a triangle, a rectangle, a polygon or a star, or an artistically configured shape. The individual EL pigment points can further be arranged geometrically exactly or randomly, for example in terms of a frequency-modulated arrangement. In both cases, however, the intermediate region between the EL pigment points should be filled with an insulating layer, the insulating layer preferably having a lower relative dielectric constant as compared with that of the EL pigment layer (12). This form of the pigment layer can also be expedient for the other pigment layers of the electroluminescent luminous arrangement according to the invention.

It is moreover possible for colour-converting dyes or pigments to be incorporated into the polymeric binder matrix of the EL layers provided in the electroluminescent luminous system according to the invention, in order thus to achieve a colour conversion of from a few 10 nm to approximately 100 nm. There may typically be mentioned in this connection pink-coloured organic dye pigments from Sinloihi®, which in conjunction with a greenish emitting EL pigment (16) effect a largely white EL emission (28). Alternatively or in addition, mixtures of two or more EL pigments having different emission wavelengths can be used as the EL pigment (16).

The electrode 2 (9) is produced analogously to the electrode 1 (8), only the overlapping electrode regions (8, 9) forming an EL field (31) according to the invention. With regard to the precise form of the electrode 2 (9), for example with regard to the composition of the electrode material, reference is made to the above comments or to the following description of electroluminescent elements.

The insulating layer (44) is preferably in the form of a transparent screen-printed layer but can likewise be in the form of a film analogous to the film (4). Before and/or after the production of the insulating layer (44), graphical printing (14, 15) can be arranged analogously to the graphical configuration (6).

If the insulating layer (44) is omitted, it is possible before and after the production of the then coincident electrodes (23) and (24) to arrange a graphical configuration on one or both sides of the electrode formed by the coincident electrodes (23) and (24).

In the case of an EL system (1) that luminesces on both sides, the electroluminescent element 2 (3) is produced analogously to the EL system 1 (2).

The electrode 3 (10) with the busbar (20) and the EL connection 3 (24) is arranged, according to the desired electrode contour, by means of screen printing on the insulating layer (44) or on the graphical configuration (15). The EL layer 2 (13) is then applied by means of screen printing analogously to the EL layer 1 (12). With regard to the precise form of the EL layer 2 (13), reference is made to the above comments relating to the EL layer 1 (12). On the EL layer 2 (13), the electrode 4 (11) with the busbar (25) and the EL connection 4 (25) is preferably contoured and more preferably applied by means of screen printing. The graphical configuration 4 (7) can optionally be provided. The arrangement is terminated by the insulating layer (5), which can be formed by means of screen printing. Alternatively or in addition, one or more transparent films can further be provided by laminating techniques.

With regard to the precise form of the electrode 3 (10) and of the electrode 4 (11), for example with regard to the composition of the electrode material, reference is made to the above comments relating to the electrode 1 (8) and the following description of electroluminescent elements.

If the EL luminous system (1) is not to be formed with EL emission on both sides, the electrode 4 (11) does not necessarily have to be transparent and can be, for example, opaque and preferably reflecting, and the graphical configuration 4 (7) can be omitted and the insulation (5) can be opaque.

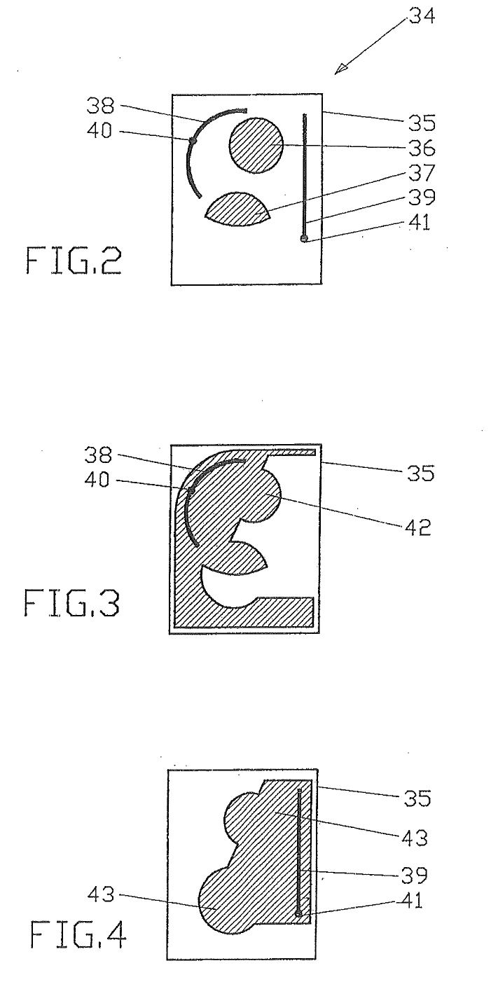

FIG. 2 shows a diagrammatic top view of an EL system (2, 3, 34) with the EL luminous fields (36, 37) on the film (35). Furthermore, the busbar (38) of the front electrode with the front electrode contact (40) and the busbar (39) of the rear electrode with the rear electrode contact (41) are shown diagrammatically. The two EL luminous fields (36, 37) are formed by overlapping regions of the front electrode (42)—see FIG. 3—and of the rear electrode (43)—see FIG. 4. The busbars (38, 39) and the busbar contacts (40, 41) are normally rendered invisible by the corresponding graphical configuration, or the busbars (38, 39) and the contacts (40, 41) are often arranged on a lateral edge or the lateral edges and are thus preferably not visible.

FIG. 3 shows a diagrammatic top view of the contoured front electrode (42) with the front electrode busbar (38) and the front electrode contact (40) on the substrate (35).

FIG. 4 shows a diagrammatic top view of the contoured rear electrode (43) with the rear electrode busbar (39) and the rear electrode contact (41) on the substrate (35).

A particularly preferred embodiment of the electroluminescent elements provided according to the invention will now be described hereinbelow, it being possible for the individual electroluminescent elements to be identical or different:

In a first embodiment of the present invention that is particularly preferred according to the invention, the electroluminescent element comprises the following layers (conventional structure):
a) an at least partially transparent substrate, component A,
b) at least one electroluminescent arrangement, component B, applied to the substrate and containing the following components:
   ba) an at least partially transparent electrode, component BA, as front electrode (cover electrode),
   bb) optionally an insulating layer, component BB,
   bc) a layer containing at least one luminous pigment excitable by an electrical field (electroluminophore), termed an electroluminescent layer or pigment layer, component BC,
   bd) optionally an insulating layer, component BD,
   be) a rear electrode, component BE, which can be at least partially transparent,
   bf) a conducting track or a plurality of conducting tracks, component BF, for the electrical contacting of both component BA as well as component BE, wherein the conducting track or the conducting tracks can be applied before, after or between the electrodes BA and BE, the conducting track or the conducting tracks preferably being applied in one work step. The conducting track or conducting tracks can be applied in the form of a silver bus, preferably produced from a silver paste. A graphite layer can possibly also be applied before the application of the silver bus,
c) a protective layer, component CA, or a film, component CB.

The insulating layers BB and BD can be non-transparent, opaque or transparent, in which connection at least one of the layers must be at least partially transparent if two insulating layers are present.

In addition, one or more at least partially transparent graphically configured layers can be arranged externally on the substrate A and/or between the substrate A and the electroluminescent arrangement.

In addition to the mentioned layers (components A, B and C), the electroluminescent element according to the invention (conventional structure) can comprise one or more reflecting layer(s). The reflecting layer(s) can in particular be arranged as follows:
externally on component A,
between component A and component BA,
between component BA and component BB, or BC if there is no component BB,
between component BD and component BE,
between component BE and component BF,
between component BF and component CA or CB,
externally on component CA or CB.

The reflecting layer, where present, is preferably arranged between component BC and component BD, or BE if there is no component BD.

The reflecting layer preferably comprises glass spheres, in particular hollow glass spheres. The diameter of the glass spheres can vary within wide limits. For example, they can have a size d₅₀ of in general from 5 μm to 3 mm, preferably from 10 to 200 μm, particularly preferably from 20 to 100 μm. The hollow glass spheres are preferably embedded in a binder.

In an alternative embodiment of the present invention the electroluminescent element consists of the following layers (reverse layer structure):
a) an at least partially transparent substrate, component A,
b) at least one electroluminescent arrangement, component B, applied to the substrate and containing the following components
   be) a rear electrode, component BE, that can be at least partially transparent,
   bb) optionally an insulating layer, component BB,
   bc) a layer containing at least one luminous pigment that can be excited by an electrical field (electroluminophore), termed an electroluminescent layer or pigment layer, component BC,
   bd) optionally an insulating layer, component BD,
   ba) an at least partially transparent electrode, component BA, as front electrode (cover electrode),
   bf) a conducting track or plurality of conducting tracks, component BF, for the electrical contacting both of component BA as well as of component BE, wherein the conducting track or conducting tracks can be applied before, after or between the electrodes BA and BE, the conducting track or conducting tracks preferably being applied in one work step. The conducting track or conducting tracks can be applied in the form of a silver bus, preferably produced from a silver paste. A graphite layer can possibly also be applied before the application of the silver bus,
c) an at least partially transparent protective layer, component CA, and/or a film, component CB.

In addition, one or more at least partially transparent graphically configured layers can be arranged on the transparent protective layer C and/or between the transparent protective layer C and the electroluminescent arrangement. In particular, the graphically configured layers can take over the function of the protective layer.

In a particular embodiment of the reverse layer structure, the above-mentioned components B, C can be applied either to the front side of the substrate, component A, or to the rear side, as well as to both sides of the substrate (double-sided structure). Layers BA to BF on both sides can thereby be identical, but they can also differ in one or more layers so that, for example, the electroluminescent element emits equally on both sides or the electroluminescent element exhibits a different colour and/or a different brightness and/or a different graphical configuration on each side.

In addition to the mentioned layers (components A, B and C), the electroluminescent element according to the invention with a reverse layer structure can include one or more reflecting layer(s). The reflecting layer(s) can in particular be arranged as follows:
externally on component A,
between component A and component BE,
between component BE and component BB,
between component BB and component BC,
between component BC and component BD,
between component BD and component BA,
between component BA and component BF,
between component BF and component CA or CB,
on component CA or CB.

The reflecting layer, where present, is preferably arranged between component BC and component BB, or BE if component BB is not present.

For the person skilled in the art it is obvious that the particular embodiments and features mentioned for the conventional structure apply as appropriate, unless otherwise stated, to the reverse layer structure and to the double-sided structure.

The one or more insulating layer(s) BB and/or BD in both the conventional structure as well as in the reverse structure can in particular be omitted if the component BC has a layer thickness that prevents a short circuit between the two electrodes, components BA and BE.

The features of the individual components of the EL element are described hereinbelow:

Electrodes

The EL element according to the invention comprises a first, at least partially transparent, front electrode (=cover electrode) BA and a second electrode, the rear electrode BE.

The expression “at least partially transparent” is understood within the scope of the present invention as meaning an electrode that is constructed of a material that has a transmission of in general more than 60%, preferably more than 70%, particularly preferably more than 80% and especially more than 90%.

The rear electrode BE need not necessarily be transparent.

Suitable electrically conducting materials for the electrodes are known to the person skilled in the art. In principle several types of electrodes are available for the production of thick-film EL elements with alternating voltage excitation. These include on the one hand indium-tin oxide electrodes (indium-tin oxides, ITO) applied in vacuo by sputtering or vapour deposition to plastics films. They are very thin (a few 100 Å) and have the advantage of a high transparency combined with a relatively low sheet resistance (ca. 60 to 600Ω).

According to the invention, a printing paste for the production of the partially transparent electrode BA is preferably formulated using from 10 to 90 wt. %, preferably from 20 to 80 wt. %, particularly preferably from 30 to 65 wt. %, in each case based on the total weight of the printing paste, of Clevios P, Clevios PH, Clevios P AG, Clevios P HCV4, Clevios P HS, Clevios PH 500, Clevios PH 510 or arbitrary mixtures thereof. As solvent there can be used dimethyl sulfoxide (DMSO), N,N-dimethylformamide, N,N-dimethylacetamide, ethylene glycol, glycerol, sorbitol, methanol, ethanol, isopropanol, n-propanol, acetone, methyl ethyl ketone, dimethylaminoethanol, water or mixtures of two, three or more of the mentioned solvents. The amount of solvent can vary in wide ranges in the printing paste. For example, one formulation according to the invention of a paste can contain from 55 to 60 wt. % of solvent, whereas in another formulation according to the invention approximately from 35 to 45 wt. % of a solvent mixture of two or more solvents can be used. Furthermore Silquest A187, Neo Rez 8986, Dynol 604 and/or mixtures of two or more of these substances can be included as surfactant additive and bonding activator. The amount of these substances is from 0.1 to 5.0 wt. %, preferably from 0.3 to 2.5 wt. %, based on the total weight of the printing paste.

As binder, the formulation can contain, for example, Bayderm Finish 85 UD, Bayhydrol PR340/1, Bayhydrol PR135 or arbitrary mixtures thereof, preferably in amounts of approximately from 0.5 to 10 wt. %, preferably from 3 to 5 wt. %. The polyurethane dispersions used according to the invention, which after the drying of the layer form the binder for the conducting layer, are preferably aqueous polyurethane dispersions.

According to the invention, particularly preferred formulations of printing pastes for the production of the partially transparent electrode BA contain:

| | Content/ | Content/ | Content/ | Content/ |
|---|---|---|---|---|
| Substance | wt. % | wt. % | wt. % | wt. % |
| Clevios P HS (H.C. | 33 | 48 | 40 | 42.2 |
| Starck) | | | | |
| Silquest A187 (OSi | 0.4 | 0.5 | 1.2 | 1.0 |
| Specialties) | | | | |
| N-methyl-pyrrolidone | 23.7 | 14.4 | 10.3 | 13.3 |
| Diethylene glycol | 26.3 | 20.7 | 30.0 | 25.4 |
| Proglyde/DMM | 12.6 | 12.4 | 14.5 | 13.6 |
| Bayderm Finish 85 UD | 4.0 | 4.0 | 4.0 | 4.5 |
| (Lanxess) | | | | |

| Substance | Content/wt. % | Content/wt. % |
|---|---|---|
| Clevios P HS (H.C. Starck) | 33 | 40 |
| Silquest A187 (OSi | 0.4 | 1.2 |
| Specialties) | | |
| N-methylpyrrolidone | 23.7 | 10.3 |
| Diethylene glycol | 26.3 | 30.0 |
| Proglyde/DMM | 12.6 | 14.5 |
| Bayhydrol P340/1 | 4.0 | 4.0 |

By way of departure from the formulations mentioned above for the partially transparent electrode BA, the following ready-for-use, commercially obtainable printing pastes mentioned here by way of example can also be used according to the invention as finished formulations: the Orgacon EL-P1000, EL-P3000, EL-P5000 or EL-P6000 ranges from Agfa, preferably the EL-P3000 and EL-P6000 ranges (in particular for formable uses).

These electrode materials can be applied, for example, by means of screen printing, knife coating, spraying and/or brushing on corresponding carrier materials (substrates), which are then preferably dried at low temperatures of, for example, from 80 to 120° C.

In a preferred alternative embodiment the application of the electrically conducting coating is carried out in vacuo or pyrolytically.

Particularly preferably in the alternative embodiment the electrically conducting coating is a metallic or metal oxide, thin and largely transparent layer produced in vacuo or pyrolytically, which preferably has a sheet resistance of from 5 mΩ/square to 3000 Ω/square, particularly preferably a sheet resistance of from 0.1 to 1000 Ω/square, most particularly preferably from 5 to 30 Ω/square, and in a further preferred embodiment has a daylight transmissibility at least greater than 60% (>60 to 100%) and in particular greater than 76% (>76 to 100%).

Furthermore electrically conducting glass can also be used as electrode.

A particularly preferred type of electrically conducting and highly transparent glass, in particular float glass, are pyrolytically produced layers that have a high surface hardness and whose electrical surface resistance can be adjusted in a very wide range from in general a few milliohms up to 3000 Ω/square.

Such pyrolytically coated glasses can be readily shaped/formed and have a good scratch resistance, and in particular scratches do not lead to an electrical interruption of the electrically conducting surface layer, but simply to a generally slight increase of the sheet resistance.

Furthermore, pyrolytically produced conducting surface layers are due to the heat treatment diffused to such a large extent and anchored in the surface that in a subsequent material application an extremely high adhesive bonding with the glass substrate is produced, which is likewise very advantageous for the present invention. In addition such coatings have a good homogeneity, and therefore only a slight variation in the surface resistance over large surfaces. This property is likewise an advantage for the present invention.

Electrically conducting and highly transparent thin layers can be produced substantially more efficiently and cost-effectively on a glass substrate, which is preferably used according to the invention, than on polymeric substrates such as PET, PMMA or PC. The electrical sheet resistance in the case of glass coatings is on average more favourable by a factor of 10 than on a polymeric film of comparable transparency, thus, for example, from 3 to 10 ohm/square in the case of glass layers compared to from 30 to 100 Ω/square on PET films.

The rear electrode, component BE, is—as in the case of the at least partially transparent electrode—a flat electrode, which however need not be transparent or at least partially transparent. This is in general applied to the insulating layer, if present. If no insulating layer is present, then the rear electrode is applied to the layer containing at least one luminous substance that can be excited by an electrical field. In an alternative embodiment the rear electrode is applied to the substrate A.

The rear electrode is in general formed from electrically conducting materials based on inorganic or organic substances, for example from metals such as silver, preference being given to the use of materials that are not damaged if the isostatic high-pressure forming process is used to produce the three-dimensionally formed film element according to the invention. Suitable electrodes include furthermore in particular polymeric electrically conducting coatings. In this case the coatings already mentioned in connection with the at least partially transparent electrode can be used. Moreover, it is possible to use those polymeric electrically conducting coatings known to the person skilled in the art that are not at least partially transparent.

The formulation of the printing paste for the rear electrode can in this connection correspond to that of the partially transparent electrode.

By way of departure from this formulation, the following formulation can, however, also be used according to the invention for the rear electrode.

A printing paste for the production of the rear electrode can be formulated using from 30 to 90 wt. %, preferably from 40 to 80 wt. %, particularly preferably from 50 to 70 wt. %, in each case based on the total weight of the printing paste, of the conducting polymers Clevios P, Clevios PH, Clevios P AG, Clevios P HCV4, Clevios P HS, Clevios PH, Clevios PH 500, Clevios PH 510 or arbitrary mixtures thereof. As solvent there can be used dimethyl sulfoxide (DMSO), N,N-dimethylformamide, N,N-dimethylacetamide, ethylene glycol, glycerol, sorbitol, methanol, ethanol, isopropanol, n-propanol, acetone, methyl ethyl ketone, dimethylaminoethanol, water or mixtures of two, three or more of these solvents. The amount of solvent that is used can vary in wide ranges. Thus, one formulation of a paste according to the invention can contain from 55 to 60 wt. % of solvent, whereas in another formulation according to the invention about 40 wt. % of a solvent mixture of three solvents is used. Furthermore, Silquest A187, Neo Rez R986, Dynol 604 or mixtures of two or more of these substances can be used as surfactant additive and bonding activator, preferably in an amount of from 0.7 to 1.2 wt. %. As binder the formulation can contain, for example, from 0.5 to 1.5 wt. % of UD-85, Bayhydrol PR340/1, Bayhydrol PR135 or arbitrary mixtures thereof.

In a further embodiment according to the invention the rear electrode can be filled with graphite. This can be accomplished by adding graphite to the formulations described above.

By way of departure from the formulations mentioned above for the rear electrode, the following ready-for-use, commercially obtainable printing pastes mentioned here by way of example can also be used according to the invention: the Orgacon EL-P1000, EL-P3000, EL-P5000 or EL-P6000 ranges from Agfa, preferably the EL-P3000 and EL-P6000 ranges (for formable uses). Graphite can also be added in this case.

The printing pastes of the Orgacon EL-P4000 range, in particular Orgacon EL-P4010 and EL-4020, can also be used specifically for the rear electrode. Both can be mixed with one another in any desired ratio. Orgacon EL-P4010 and EL-4020 already contain graphite.

Graphite pastes that can be obtained commercially, for example graphite pastes from Acheson, in particular Electrodag 965 SS or Electrodag 6017 SS, can also be used as the rear electrode.

A particularly preferred formulation according to the invention of a printing paste for producing the rear electrode BE contains:

| | Content/ | Content/ | Content/ |
|---|---|---|---|
| Substance | wt.-% | wt.-% | wt.-% |
| Clevios P HS | 58.0 | 50.7 | 64.0 |
| Silquest A187 | 2.0 | 1.0 | 1.6 |
| NMP (e.g. BASF) | 17.0 | 12.1 | 14.8 |
| DEG | 10.0 | 23.5 | 5.9 |
| DPG/DMM | 10.0 | 8.6 | 10.2 |
| Bayderm Finish 85 | 3.0 | 4.1 | 3.5 |
| UD (Lanxess) | | | |

| Substance | Content/wt.-% | Content/wt.-% |
|---|---|---|
| Clevios P HS | 58.0 | 50.7 |
| Silquest A187 | 2.0 | 1.0 |
| NMP (e.g. BASF) | 17.0 | 12.1 |
| DEG | 10.0 | 23.5 |
| DPG/DMM | 10.0 | 8.6 |
| Bayhydrol P340/1 | 3.0 | 4.1 |

Conducting Tracks, Connections of the Electrodes

In the case of large area luminous elements with a luminous capacitor structure, the surface conductivity plays a significant role as regards a uniform luminous density. In the case of large area luminous elements so-called busbars are frequently used as conducting tracks, component BF, especially with semiconducting LEP (light-emitting polymers), PLED and/or OLED systems, in which relatively large currents flow. In this case very highly electrically conducting tracks are formed in the manner of a cross. In this manner a large surface area, for example, is subdivided into four small areas. The voltage drop in the middle region of a luminous surface is thereby significantly reduced and the uniformity of the luminous density and the decrease in brightness in the centre of a luminous field is reduced.

In the case of a zinc sulfide particular EL field employed in one embodiment according to the invention, in general alternating voltages greater than 100 volts and up to more than 200 volts are applied, and very low currents flow if a good dielectric material or good insulation are employed. In the ZnS thick-film AC-EL element according to the invention the problem of current loading is therefore substantially less than in the case of semiconducting LEP or OLED systems, so that the use of busbars is not absolutely essential, but instead large area luminous elements can already be installed without using busbars.

Preferably according to the invention it is sufficient if the silver bus in the case of areas smaller than DIN A3 is printed only on the edge of the electrode layer BA or BE; with areas larger than DIN A3 it is preferred according to the invention if the silver bus forms at least one additional conducting track.

The electrical connections can be produced, for example, by using electrically conducting and stovable pastes containing tin, zinc, silver, palladium, aluminium and further suitable conducting metals, or combinations and mixtures or alloys thereof.

In this connection the electrically conducting contacting strips are generally applied by means of screen printing, brush application, ink-jet, knife coating, roller application, spraying, or by means of dispenser application or comparable application methods known to the person skilled in the art, to the electrically conducting and at least partially transparent thin coatings, and are then generally heat treated in an oven so that strips normally applied laterally along a substrate edge can be effectively contacted in an electrically conducting manner by means of soldering, clamping or plug-in connection.

So long as only very small electrical outputs have to be initiated on electrically conducting coatings, spring contacts or carbon-filled rubber elements or so-called zebra rubber strips are sufficient.

Conducting adhesive pastes based on silver, palladium, copper or gold-filled polymer adhesives are preferably used as conducting adhesive pastes. Self-adhesive, electrically conducting strips of, for example, tin-plated copper foil with an electrically conducting adhesive in the z-direction can likewise be applied by contact pressing.

The adhesive layer is in this case generally uniformly pressed in by exerting a surface pressure of a few N/cm², and depending on the implementation, values of 0.013 Ω/cm² (for example conductive copper foil tape VE 1691 from D & M International, A-8451 Heimschuh) or 0.005Ω (for example type 1183 from 3M Electrical Products Division, Austin, Tex. USA; according to MIL-STD-200 Method 307 maintained at 5 psi/3.4 N/cm² measured over 1 sq.in. surface area) or 0.001Ω (for example type 1345 from 3M) or 0.003Ω (for example type 3202 from Holland Shielding Systems BV) are thereby achieved.

The contacting can, however, be carried out by all methods known to the person skilled in the art, for example crimping, plugging in, clamping, riveting or bolting/screwing.

Dielectric Layer

The EL element according to the invention preferably comprises at least one dielectric layer, component BD, which is provided between the rear electrode, component BE, and the EL layer, component BC.

A further dielectric layer BB can also be present between the cover electrode, component BA, and the EL layer, component BC.

Corresponding dielectric layers are known to the person skilled in the art. Corresponding layers often include highly dielectrically acting powders, such as, for example, barium titanate, which are preferably dispersed in fluorine-containing plastics or in cyano-based resins. Examples of particularly suitable particles are barium titanate particles in the range of preferably from 1.0 to 2.0 μm. With a high degree of filling these can produce a relative dielectric constant of up to 100.

The dielectric layer has a thickness of generally from 1 to 50 μm, preferably from 2 to 40 μm, particularly preferably from 5 to 25 μm, especially from 8 to 20 μm.

The EL element according to the invention can in one embodiment also additionally contain a further dielectric layer, which layers are arranged above one another and together improve the insulation effect, or which is interrupted by a floating electrode layer. The use of a second dielectric layer can depend on the quality and pinhole freedom of the first dielectric layer.

As fillers there are used inorganic insulating materials which are known to the person skilled in the art from the literature, for example: BaTiO₃, SrTiO₃, KNbO₃, PbTiO₃, LaTaO₃, LiNbO₃, GeTe, Mg₂TiO₄, Bi₂(TiO₃₎₃, NiTiO₃, CaTiO₃, ZnTiO₃, Zn₂TiO₄, BaSnO₃, Bi(SnO₃)₃, CaSnO₃, PbSnO₃, MgSnO₃, SrSnO₃, ZnSnO₃, BaZrO₃, CaZrO₃, PbZrO₃, MgZrO₃, SrZrO₃, ZnZrO₃ and lead zirconate-titanate mixed crystals or mixtures of two or more of these fillers. Preferred fillers according to the invention are BaTiO₃ or PbZrO₃ or mixtures thereof, preferably in filling amounts of from 5 to 80 wt. %, preferably from 10 to 75 wt. %, particularly preferably from 40 to 70 wt. %, in each case based on the total weight of the paste, in the paste used to produce the insulating layer.

One-component or preferably two-component polyurethane systems can be used as binder for this layer, preferably the systems available from Bayer MaterialScience AG, particularly preferably Desmodur and Desmophen or the lacquer raw materials of the Lupranate, Lupranol, Pluracol or Lupraphen ranges from BASF AG; from Degussa AG (Evonik), preferably vestanate, particularly preferably vestanate T and B; or from the Dow Chemical Company, preferably vorastar. Furthermore highly flexible binders can also be used, for example those based on PMMA, PVA, in particular mowiol and poval from Kuraray Specialties Europe GmbH or polyviol from Wacker AG, or PVB, in particular mowital from Kuraray Specialties Europe GmbH (B 20 H, B 30 T, B 30 H, B 30 HH, B 45 H, B 60 T, B 60 H, B 60 HH, B 75 H), or pioloform, in particular pioloform BR18, BM18 or BT18, from Wacker AG.

As solvents there may, for example, be used ethyl acetate, butyl acetate, 1-methoxypropyl acetate-2, toluene, xylene, solvesso 100, shellsol A or mixtures of two or more of these solvents. If, for example, PVB is used as binder, also methanol; ethanol, propanol, isopropanol, diacetone alcohol, benzyl alcohol, 1-methoxypropanol-2, butyl glycol, methoxybutanol, dowanol, methoxypropyl acetate, methyl acetate, ethyl acetate, butyl acetate, butoxyl, glycolic acid n-butyl ester, acetone, methyl ethyl ketone, methyl isobutyl ketone, cyclohexanone, toluene, xylene, hexane, cyclohexane, heptane, as well as mixtures of two or more of the mentioned solvents, in amounts of from 1 to 30 wt. % based on the total weight of the paste, preferably from 2 to 20 wt. %, particularly preferably from 3 to 10 wt. % Furthermore additives such as flow improvers and rheology additives can be added in order to improve the properties. Examples of flow improvers are Additol XL480 in butoxyl in a mixing ratio of from 40:60 to 60:40. The paste can contain further additives from 0.01 to 10 wt. %, preferably from 0.05 to 5 wt. %, particularly preferably from 0.1 to 2 wt. %, in each case based on the total weight of paste. As rheology additives, which reduce the settling behaviour of pigments and fillers in the paste, there can, for example, be used BYK 410, BYK 411, BYK 430, BYK 431 or arbitrary mixtures thereof.

Particularly preferred formulations according to the invention of a printing paste for the production of the insulating layer as component BB and/or BD contain:

| | Content/ | Content/ | Content/ | Content/ |
|---|---|---|---|---|
| Substance | wt. % | wt. % | wt. % | wt. % |
| BaTiO₃ | 50 | 50 | 50 | 55 |
| Desmophen 1800 (BMS) | 25 | 25 | 25 | 22.5 |
| Desmodur L67 MPA/X | 14 | 14 | 14 | 11.4 |
| (BMS) | | | | |
| Ethoxypropyl acetate | 8.7 | 0 | 4 | 0 |
| Methoxypropyl acetate | 0 | 8.7 | 4.7 | 8.6 |
| Additol XL480 | 2.3 | 2.3 | 2.3 | 2.5 |
| (50 wt. % in butoxyl) | | | | |

| | Content/ | Content/ | Content/ | Content/ |
|---|---|---|---|---|
| Substance | wt. % | wt. % | wt. % | wt. % |
| BaTiO₃ | 55 | 56.6 | 59.9 | 59.9 |
| Desmophen 1800 (BMS) | 22.5 | 20.3 | 19.9 | 19.9 |
| Desmodur L67 MPA/X | 11.4 | 12.5 | 11.2 | 11.2 |
| (BMS) | | | | |
| Ethoxypropyl acetate | 8.6 | 7.6 | 5.7 | 0 |
| Methoxypropyl acetate | 0 | 0 | 0 | 5.7 |
| Additol XL480 in | 2.5 | 3.0 | 3.3 | 3.3 |
| butoxyl 50% | | | | |

| | Content/ | | Content/ |
|---|---|---|---|
| Substance | wt. % | Substance | wt. % |
| BaTiO₃ | 55 | BaTiO₃ | 60.2 |
| Desmophen 1800 | 22.5 | Desmophen 670 | 14.3 |
| (BMS) | | (BMS) | |
| Desmodur L67 | 12 | Desmodur | 12.3 |
| MPA/X (BMS) | | N75MPA (BMS) | |
| Ethoxypropyl | 8 | Ethoxypropyl | 10.3 |
| acetate | | acetate | |
| Additol XL480 | 2.5 | Additol XL480 | 2.9 |
| (50 wt. % in | | (50 wt. % in | |
| butoxyl) | | butoxyl) | |

EL Layer

The EL element according to the invention comprises at least one EL layer, component BC. The at least one EL layer can be arranged on the entire inner surface of the first partially transparent electrode or on one or more partial surfaces of the first at least partially transparent electrode. In the case where the EL layer is arranged on several partial surfaces, the partial surfaces generally have a mutual interspacing of from 0.5 to 10.0 mm, preferably from 1 to 5 mm.

The EL layer is in general composed of a binder matrix with EL pigments homogeneously dispersed therein. The binder matrix is generally chosen so as to produce a good adhesive bonding to the electrode layer (or to the dielectric layer optionally applied thereto). In a preferred embodiment, systems based on PVB or PU are used. In addition to the EL pigments, further additives may optionally also be present in the binder matrix, such as colour-converting organic and/or inorganic systems, colorant additives for a day- and night-time light effect and/or reflecting and/or light-absorbing effect pigments such as aluminium flakes, glass flakes or mica platelets.

The EL pigments used in the EL layer generally have a thickness of from 1 to 50 μm, preferably from 5 to 25 μm.

The at least one EL layer BC is preferably an alternating current thick-film powder electroluminescent (AC-P-EL) luminous structure.

Within the scope of the present invention, EL elements are understood as meaning thick-film EL systems that are operated by means of alternating voltage at normally 100 volts and 400 Hz and in this way emit a so-called cold light of a few cd/m² up to several 100 cd/m² or more (thick-film AC-EL elements). EL screen printing pastes are generally used in such inorganic thick-film alternating voltage EL elements.

Such EL screen printing pastes are generally formulated on the basis of inorganic substances. Suitable substances are, for example, highly pure ZnS, CdS, ZnₓCd₁₋ₓS compounds of groups II and IV of the Periodic System of the Elements, ZnS being particularly preferably used. The above-mentioned substances can be doped or activated and optionally also co-activated. Copper and/or manganese, for example, are used for the doping. The co-activation is carried out, for example, with chlorine, bromine, iodine and aluminium. The content of alkali metals and rare earth metals in the above-mentioned substances is generally very low, if these are present at all. Most particular preference is given to the use of ZnS, which is preferably doped or activated with copper and/or manganese and is preferably co-activated with chlorine, bromine, iodine and/or aluminium.

Normal EL emission colours are yellow, orange, green, green-blue, blue-green and white, the emission colours white or red being able to be obtained by mixtures of suitable EL pigments or by colour conversion. The colour conversion can generally be implemented in the form of a converting layer and/or by admixture of appropriate dyes and pigments in the polymeric binder of the screen printing inks or in the polymeric matrix in which the EL pigments are incorporated.

In a further embodiment of the present invention, the screen printing matrix used for the production of the EL layer is provided with glazing, colour-filtering or colour-converting dyes and/or pigments. The emission colour white or a day/night light effect can be generated in this manner.

In a further embodiment, the pigments used in the EL layer have an emission in the blue wavelength range from 420 to 480 nm and are provided with a colour-converting microencapsulation. The colour white can be emitted in this manner.

In one embodiment, the pigments used in the EL layer are AC-P-EL pigments that have an emission in the blue wavelength range from 420 to 480 nm. In addition, the AC-P-EL screen printing matrix preferably contains wavelength-converting inorganic fine particles based on europium(II)-activated alkaline earth orthosilicate luminous pigments such as (Ba, Sr, Ca)₂SiO₄:Eu²⁺ or YAG luminous pigments such as Y₃Al₅O₁₂:Ce³⁺ or Tb₃Al₅O₁₂:Ce³⁺ or Sr₂GaS₄:Eu²⁺ or SrS:Eu²⁺ or (Y,Lu,Gd,Tb)₃(Al,Sc,Ga)₅O₁₂:Ce³⁺ or (Zn,Ca,Sr)(S,Se):Eu²⁺. A white emission can also be achieved in this manner.

Corresponding to the prior art, the above-mentioned EL pigments can be microencapsulated. Good half-life times can be achieved by the inorganic microencapsulation techniques. The EL screen printing system Luxprint® for EL from E.I. du Pont de Nemours and Companies may be mentioned here by way of example. Organic microencapsulation techniques and film-wrap laminates based on the various thermoplastic films are in principle also suitable, but they have proved to be expensive and do not significantly prolong the service life.

Suitable zinc sulfide microencapsulated EL luminous pigments are available from Osram Sylvania, Inc. Towanda under the trade names GlacierGLO™ Standard, High Brite and Long Life, and from the Durel Division of the Rogers Corporation under the trade names 1PHS001® High-Efficiency Green Encapsulated EL Phosphor, 1PHS002® High-Efficiency Blue-Green Encapsulated EL Phosphor, 1PHS003® Long-Life Blue Encapsulated EL Phosphor, 1PHS004® Long-Life Orange Encapsulated EL Phosphor.

The mean particle diameters of the suitable microencapsulated pigments in the EL layer are generally from 15 to 60 μm, preferably from 20 to 35 μm.

Non-microencapsulated fine grain EL pigments, preferably with a high service life, can also be used in the EL layer of the EL element according to the invention. Suitable non-microencapsulated fine grain zinc sulfide EL pigments are disclosed, for example, in U.S. Pat. No. 6,248,261 and in WO 01/34723. These preferably have a cubic crystal lattice structure. The non-microencapsulated pigments preferably have mean particle diameters of from 1 to 30 um, particularly preferably from 3 to 25 μm, most particularly preferably from 5 to 20 μm.

Specifically, non-microencapsulated EL pigments with smaller pigment dimensions down to below 10 μm can be used. The transparency of the glass element can thereby by increased.

Thus, unencapsulated pigments can be admixed with the suitable screen printing inks according to the present invention, preferably having regard to the special hygroscopic properties of the pigments, preferably the ZnS pigments. In this connection binders are generally used that on the one hand have a good adhesion to so-called ITO layers (indium-tin oxide) or to intrinsically conducting polymeric transparent layers, and that on the other hand have a good insulating effect, strengthen the dielectric and thereby effect an improvement of the breakdown strength at high electric field strengths, and in addition in the cured state exhibit a good water vapour barrier and additionally protect the EL pigments and prolong the service life.

In one embodiment of the present invention pigments that are not microencapsulated are used in the AC-P-EL luminous layer.

The half-life times of the suitable pigments in the EL layer, i.e. the time during which the initial brightness of the EL element according to the invention has fallen by half, are in general at 100 volts and 80 volts and 400 Hz, from 400 hours up to a maximum of 5000 hours, but usually not more than 1000 to 3500 hours.

The brightness values (EL emission) are in general from 1 to 200 cd/m², preferably from 3 to 100 cd/m², particularly preferably from 5 to 40 cd/m²; with large luminous surface areas the brightness values are preferably in the range from 1 to 50 cd/m².

Pigments with longer or shorter half-life times and higher or lower brightness values can, however, also be used in the EL layer of the EL element according to the invention.

In a further embodiment of the present invention the pigments present in the EL layer have such a small mean particle diameter, or such a low degree of filling in the EL layer, or the individual EL layers are configured geometrically so small, or the interspacing of the individual EL layers is chosen so large, that the EL element in the case of non-electrically activated luminous structures is configured to be at least partially transparent or to ensure transmissibility. Suitable pigment particle diameters, degrees of filling, dimensions of the luminous elements and interspacings of the luminous elements have been mentioned hereinbefore.

The layer contains the above-mentioned, optionally doped ZnS crystals, preferably microencapsulated as described above, preferably in an amount of from 40 to 90 wt. %, more preferably from 50 to 80 wt. %, particularly preferably from 55 to 70 wt. %, in each case based on the weight of the paste. One-component and preferably two-component polyurethanes can be used as binder. Preferred according to the invention are highly flexible materials from Bayer MaterialScience AG, for example the lacquer raw materials of the Desmophen and Desmodur ranges, preferably Desmophen and Desmodur, or the lacquer raw materials of the Lupranate, Lupranol, Pluracol or Lupraphen ranges from BASF AG. As solvents there can be used ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or arbitrary mixtures of two or more of these solvents, in amounts of preferably from 1 to 50 wt. %, more preferably from 2 to 30 wt. %, particularly preferably from 5 to 15 wt. %, in each case based on the total mass of the paste. Furthermore, other highly flexible binders, for example those based on PMMA, PVA, in particular mowiol and poval from Kuraray Specialties GmbH, or polyviol from Wacker AG, or PVB, in particular mowital from Kuraray Specialties GmbH (B 20 H, B 30 T, B 30 H, B 30 HH, B 45 H, B 60 T, B 60 H, B 60 HH, B 75 H), or pioloform, in particular pioloform BR18, BM18 or BT18, from Wacker AG, can be used. When using polymeric binders such as, for example, PVB, solvents such as methanol, ethanol, propanol, isopropanol, diacetone alcohol, benzyl alcohol, 1-methoxypropanol-2, butyl glycol, methoxybutanol, dowanol, methoxypropyl acetate, methyl acetate, ethyl acetate, butyl acetate, butoxyl, glycolic acid n-butyl ester, acetone, methyl ethyl ketone, methyl isobutyl ketone, cyclohexanone, toluene, xylene, hexane, cyclohexane, heptane as well as mixtures of two or more of the above-mentioned solvents can furthermore be added in amounts of from 1 to 30 wt. % based on the total mass of the paste, preferably from 2 to 20 wt. %, particularly preferably from 3 to 10 wt. %.

In addition, from 0.1 to 2 wt. % of additives can be present in order to improve the flow behaviour and the flow. Examples of flow improvers are Additol XL480 in butoxyl in a mixing ratio of from 40:60 to 60:40. As further additives, from 0.01 to 10 wt. %, preferably from 0.05 to 5 wt. %, particularly preferably from 0.1 to 2 wt. %, in each case based on the total mass of the paste, of rheology additives can be present, which reduce the settling behaviour of pigments and fillers in the paste, for example BYK 410, BYK 411, BYK 430, BYK 431 or arbitrary mixtures thereof.

According to the invention, particularly preferred formulations of printing pastes for the production of the EL luminous pigment layer as component BC contain:

| | Content/ | Content/ | Content/ | Content/ |
|---|---|---|---|---|
| Substance | wt. % | wt. % | wt. % | wt. % |
| Pigment (Osram | 55.3 | 69.7 | 64.75 | 65.1 |
| Sylvania) | | | | |
| Desmophen D670 (BMS) | 18.5 | 11.9 | 12.7 | 13.1 |
| Desmodur N75 MPA | 16.0 | 9.0 | 12.4 | 11.3 |
| (BMS) | | | | |
| Ethoxypropyl acetate | 9.8 | 9.1 | 9.9 | 10.2 |
| Additol XL480 | 0.4 | 0.3 | 0.25 | 0.3 |
| (50 wt. % in butoxyl) | | | | |

| | Content/ | Content/ | Content/ |
|---|---|---|---|
| Substance | wt. % | wt. % | wt. % |
| Pigment (Osram Sylvania) | 61.2 | 65.1 | 69.7 |
| Desmophen D670 (BMS) | 15.2 | 12.7 | 11.9 |
| Desmodur N75 MPA (BMS) | 13.1 | 11.4 | 9.0 |
| Methoxypropyl acetate | 10.2 | 5.5 | 4.9 |
| Ethoxypropyl acetate | 0 | 5 | 4.2 |
| Additol XL480 (50 wt. % in butoxyl) | 0.3 | 0.3 | 0.3 |

| | Content/ | Content/ |
|---|---|---|
| Substance | wt. % | wt. % |
| Pigment (Osram Sylvania) | 61.2 | 69.7 |
| Desmophen 1800 (BMS) | 17.7 | 14.1 |
| Desmodur L67 MPA/X (BMS) | 9.9 | 7.9 |
| Ethoxypropyl acetate | 10.8 | 8.0 |
| Additol XL480 (50 wt. % in butoxyl) | 0.4 | 0.3 |

Cover Layer

In addition to components A and B, the EL element according to the invention contains a protective layer, component CA, in order to prevent destruction of the electroluminescent element or of the graphical representations which may be present. Suitable materials for the protective layer are known to the person skilled in the art. Suitable protective layers CA are, for example, high temperature resistant protective lacquers such as protective lacquers containing polycarbonates and binders. An example of such a protective lacquer is Noriphan® HTR from Pröll, Weiβenburg.

Alternatively, the protective layer can also be formulated on the basis of flexible polymers such as polyurethanes, PMMA, PVA or PVB. Polyurethanes from Bayer MaterialScience AG can be used for this purpose. This formulation can also be provided with fillers. All fillers known to the person skilled in the art are suitable for this purpose, for example those based on inorganic metal oxides such as TiO₂, ZnO, lithopones, etc., with a degree of filling of from 10 to 80 wt. % of the printing paste, preferably a degree of filling of from 20 to 70%, particularly preferably from 40 to 60%. Furthermore, the formulations can contain flow improvers as well as rheology additives. As solvents there can be used, for example, ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or mixtures of two or more of these solvents.

According to the invention, particularly preferred formulations of the protective lacquer CA contain, for example:

| | Content/ | Content/ | Content/ | Content/ |
|---|---|---|---|---|
| Substance | wt. % | wt. % | wt. % | wt. % |
| Desmophen 670 (BMS) | 18.9 | 22.0 | 17.3 | 22.0 |
| Additol XL480 | 1.2 | 0.8 | 1.0 | 0.8 |
| (50 wt. % in butoxyl) | | | | |
| Desmodur N75 MPA | 20.0 | 20.0 | 17.4 | 20.0 |
| (BMS) | | | | |
| Ethoxypropyl acetate | 4.5 | 8.5 | 4.3 | 0 |
| Methoxypropyl acetate | 0 | 0 | 0 | 8.5 |
| TiO₂ | 55.4 | 48.7 | 60.0 | 48.7 |

| | Content/ |
|---|---|
| Substance | wt. % |
| Desmophen 1800 (BMS) | 22.9 |
| Additol XL480 (50 wt. % in butoxyl) | 1.1 |
| Desmodur L67 MPA/X (BMS) | 12.9 |
| Ethoxypropyl acetate | 10.6 |
| TiO₂ | 52.5 |

Substrates

The EL element according to the invention can comprise on one or both sides of the respective electrodes, substrates such as for example glasses, plastics films or the like, in addition to the textile carrier material.

In the EL element according to the invention it is preferred if at least the substrate that is in contact with the transparent electrode is designed to be graphically glazingly translucent and opaquely covering on the inside. An opaque covering design is understood to mean a large area electroluminescence region that is opaquely covered by a high-resolution graphical design and/or is formed glazingly, for example in the sense of red-green-blue, translucently for signalling purposes.

In addition it is preferred if the substrate that is in contact with the transparent electrode BA is a film that is cold-stretchably workable below the glass transition temperature Tg. In this manner the possibility is provided of working the resulting EL element three-dimensionally.

Furthermore it is preferred if the substrate that is in contact with the rear electrode BE is a film that is likewise cold-stretchably workable below Tg. In this manner the possibility is provided of working the resulting EL element three-dimensionally.

The EL element is thus three-dimensionally workable, wherein the radii of curvature may be less than 2 mm, preferably less than 1 mm. The working angle can in this connection be greater than 60°, preferably greater than 75°, particularly preferably greater than 90° and especially greater than 105°.

Moreover, it is preferred if the EL element is three-dimensionally workable and in particular is cold-stretchably workable below Tg and in this manner receives a precise, worked three-dimensional shape. The three-dimensionally worked element can be moulded on at least one side with a thermoplastic material in an injection mould.

Production of Corresponding EL Elements

Normally the pastes mentioned hereinbefore (screen printing pastes) are applied to transparent plastics films or glasses, which in turn comprise a largely transparent electrically conducting coating and thereby form the electrode for the visible side. The dielectric, if present, and the rear side electrode are then produced by printing techniques and/or lamination techniques.

A reverse production process is also possible, however, in which first of all the rear side electrode is produced or the rear side electrode is used in the form of a metallised film and the dielectric is applied to this electrode. The EL layer and following this the transparent and electrically conducting upper electrode are then applied. The resulting system can then optionally be laminated with a transparent cover film and thereby protected against water vapour and also against mechanical damage.

In one embodiment of the invention, the conducting tracks (silver bus) can be applied as first layer to the substrate A. According to the invention they are, however, preferably applied to the electrodes BA and BE either in two work stages, in each case individually to the electrodes, or in one work step to the electrodes jointly.

The EL layer is normally applied by a printing technique by means of screen printing or dispenser application or ink jet application, or also in a knife coating procedure or a roller coating method or a curtain casting method or a transfer method, preferably by means of screen printing. The EL layer is preferably applied to the surface of the electrode or to the insulating layer optionally applied to the rear electrode.

On the basis of the above comments and explanations, preferred embodiments of the present invention relate to the following EL luminous systems:
(1) In a first preferred embodiment the present invention relates to an at least single-layer flat EL luminous system (1) based on at least one inorganic thick-film AC-EL element (2 and/or 3, abbreviated hereinbelow to 2/3, for example) having at least two electrically conducting flat electrodes, wherein at least one of the at least two flat electrodes is largely transparent and at least one of the two electrodes has a graphically configured contour and the two electrode surfaces do not overlap completely, so that an EL emission takes place only in those regions of the EL luminous system in which the two corresponding electrodes overlap.
   In this first embodiment an EL layer is arranged between the two corresponding electrodes, it being possible for the EL emission in the overlapping electrode regions to have a different emission colour.
   By combining two such EL elements in an electroluminescent luminous system and operating the at least two EL elements with two alternating voltages, a resulting luminous system corresponding to the graphical configuration of the four flat electrodes can be obtained.
(2) In a second embodiment the present invention relates to a single-layer flat EL luminous system (1) based on at least one inorganic thick-film AC-EL element (2) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, the EL luminous system being in single-layer form.
   Within the scope of the present invention the expression “in single-layer form” is understood as meaning that only one EL element, comprising two electrodes and one EL layer and optionally an insulating layer, is provided in the EL luminous system (1).
(3) In a third embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, the EL luminous system being multi-layer, in particular double-layer.
   Within the scope of the present invention the expression “in double-layer form” is understood as meaning that two EL elements, each comprising two electrodes and one EL layer and optionally an insulating layer, are provided in the EL luminous system (1).
(4) In a fourth embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, further EL elements being arranged in layer form in addition to the at least one EL element (2/3).
   Within the scope of the present invention, the resulting electroluminescent luminous system according to the invention is accordingly in multi-layer form (in the sense of more than two layers).
(5) In a fifth embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous arrangement in which the two corresponding electrodes overlap, the at least one EL layer (12/13) being in such a form that the EL pigments (16/17) contained in that layer are distributed largely homogeneously in a polymeric binder matrix and/or the polymeric binder matrix has insulating properties.
   If two or more EL elements are to be used in this embodiment, that is to say if the EL luminous system according to the invention is to be in multi-layer form within the scope of the present invention, the homogeneous distribution can be produced in one, in a plurality or in all of the EL elements.
   If two or more EL elements are to be used in this embodiment, that is to say if the EL luminous system according to the invention is in multi-layer form within the scope of the present invention, the binder matrix in one, in a plurality or in all of the EL elements can have insulating properties.
(6) In a sixth embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, the at least one EL element (2/3) being largely transparent or translucent.
   If two or more EL elements are to be used in this embodiment, that is to say if the EL luminous system according to the invention is in multi-layer form within the scope of the present invention, the corresponding largely transparent or translucent form can be produced in one, in a plurality or in all of the EL elements.
   Within the scope of the present invention the term “transparent” is in principle understood as meaning a material which, in the applied state, has a transmission of generally more than 60%, preferably more than 70%, particularly preferably more than 80%, especially more than 90%.
   By means of this configuration, the EL emission (28, 29, 30) can thus be emitted upwards and/or the EL emission (28′, 29′, 30′) can be emitted downwards.
(7) In a seventh embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, the EL luminous system having at least one, preferably two, particularly preferably three, in particular four, of the graphical layers (6, 7/14, 15).
   In a further preferred form, those graphical layers have masking, opaque, glazing, translucent, colour-filtering, colour-converting, semi-transparent and/or reflecting flat regions.
   Those regions can be present in one or more of the graphic layers.
(8) In an eighth embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous arrangement in which the two corresponding electrodes overlap, the different EL layers (12, 13) in the case of an at least two-layer EL luminous system containing EL pigments (16/17) having different emission wavelengths.
(9) In a ninth embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, at least one of the EL layers containing a polymeric binder matrix and/or containing added colour-converting substances in terms of a Stokes displacement by a few 10 to approximately 100 nm.
   If two or more EL elements are used in the EL luminous arrangement within the scope of the present invention, then the polymeric binder matrix can also be present in a plurality of the EL layers, for example in two or in all of the EL layers.
   If two or more EL elements are used in the EL luminous arrangement within the scope of the present invention, then the added colour-converting substances can also be present in a plurality of the EL layers, for example in two or in all of the EL layers.
(10) In a tenth embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, at least one EL layer not covering the entire surface but being configured pointwise.
   Increased transparency can be achieved thereby. The individual points can have geometrically exact shapes or randomly graphically configured shapes, so that the EL luminous system is in geometrically exact form or in random form in terms of a random distribution or in frequency-modulated form. The spaces between the individual points are preferably filled with a transparent binder matrix having a low relative dielectric constant as compared with the relative dielectric constant of the EL layers.
   This configuration can be produced both in one of the EL layers present in the EL arrangement according to the invention and in a plurality of EL layers, for example in two or all of the EL layers.
(11) In an eleventh embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, the entire EL luminous system (1) being formable in a stress-whitening-free manner.
(12) In a twelfth embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, the entire EL luminous arrangement (1) being deformable below Tg by means of an isostatic high-pressure forming process, for example according to the process described in EP 0 371 425, The corresponding disclosure of EP 0 371 425 is incorporated by way of reference in the present invention.
(13) In a thirteenth embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, the entire EL luminous arrangement (1) being deformable below Tg by means of an isostatic high-pressure forming process, for example according to the process described in EP 0 371 425 A, and being deformable and sprayable on the back according to the 3D-EL-IMD process (IMD: In Mould Decoration, process of spraying the back of EL films according to the process described in EP 0 978 220 A). The corresponding disclosure of EP 0 987 220 A is incorporated by way of reference in the present invention.
(14) In a fourteenth embodiment the present invention relates to an at least single-layer flat EL luminous system (1) based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, at least one EL element being connected with the respective EL connections to an alternating voltage and the EL element effecting an EL emission in dependence on the level of the voltage and the frequency and dynamic light effects being effected by changing the voltages or frequencies with time.
   In particular in the case of two EL elements, these are connected with the EL connections (22, 23) and EL connections (24, 25) to an alternating voltage and effect an EL emission (28, 29, 30) according to the level of the voltage and the frequency or, in the case of light emission on both sides, additionally an EL emission (28′, 29′, 30′) and dynamic light effects by changing the voltages or frequencies with time.

The present invention relates further to a process for the production of an at least single-layer flat EL luminous system (1) according to the invention based on at least one inorganic thick-film AC-EL element (2/3) having at least two electrically conducting flat electrodes, wherein at least one of the at least two flat electrodes is largely transparent, at least one of the two electrodes has a graphically configured contour and the two electrode surfaces do not overlap completely, so that an EL emission takes place only in those regions of the EL luminous system in which the two corresponding electrodes overlap, by means of screen printing and lamination.

An EL layer is arranged between two corresponding electrodes, and the EL emission can have a different emission colour in the overlapping electrode regions. In that manner it is possible, by operating the at least two EL elements with two alternating voltages, to obtain a luminous arrangement corresponding to the graphical configuration of the four flat electrodes.

In this process a screen printing process is preferably used to produce the layers (8, 18, 22, 12, 9, 23, 10, 24, 13, 11, 21) and those layers (8, 18, 22, 12, 9, 23, 10, 24, 13, 11, 21) are preferably printed onto either the film (4) or the film (5).

The present invention further provides the use of the EL luminous system according to the invention as a lamp, as an advertising object and/or as an artistic structure.

### LIST OF REFERENCE NUMERALS

1 multi-layer EL luminous system consisting of at least two EL elements (2, 3)
2 EL element 1
3 EL element 2
4 upper insulation: film or layer; transparent
5 lower insulation: film or layer; opaque or transparent
6 graphical configuration 1—upper: opaque or translucent or glazing
7 graphical configuration 4—lower: optional, depending on the design with EL emission on both sides or on only one side
8 electrode 1: upper flat electrically conducting and largely transparent thin layer, preferably configured graphically by means of screen printing
9 electrode 2: flat electrically conducting and largely transparent thin layer, preferably configured graphically by means of screen printing
10 electrode 3: flat electrically conducting and largely transparent thin layer, preferably configured graphically by means of screen printing
11 electrode 4: flat electrically conducting and either largely transparent or opaque thin layer, preferably configured graphically by means of screen printing
12 EL layer 1
13 EL layer 2
14 graphical configuration 2
15 graphical configuration 3
16 EL pigments in the first EL layer
17 EL pigments in the second EL layer
18 busbar of the first electrode
19 busbar of the second electrode
20 busbar of the third electrode
21 busbar of the fourth electrode
22 EL connection of the first electrode
23 EL connection of the second electrode
24 EL connection of the third electrode
25 EL connection of the fourth electrode
26 upper observer
27 lower observer: optional in the case of EL emission on both sides
28 EL emission 1 upwards
29 EL emission 2 upwards
30 EL emission 2/1 upwards
28′ EL emission 1 downwards
29′ EL emission 2 downwards
30′ EL emission 1/2 downwards
31 EL emission region 1 upwards
32 EL emission region 2 upwards
33 EL emission region 1/2 upwards
31′ EL emission region 1 downwards
32′ EL emission region 2 downwards
33′ EL emission region 1/2 downwards
34 EL luminous system 1 in a diagrammatic representation
35 transparent substrate or film
36 luminous field 1—upper
37 luminous field 2—lower
38 busbar front electrode
39 busbar rear electrode
40 contact front electrode
41 contact rear electrode
42 front electrode
43 rear electrode
44 insulation (film, layer) transparent

1.-16. (canceled)

17. An electroluminescent (EL) luminous system having at least one layer and being based on at least one inorganic thick-film AC-electroluminescent (EL) element, comprising at least one EL element having at least two electrically conducting flat electrodes and an EL layer, wherein the electrode surfaces are arranged relative to one another so that the electrode surfaces do not overlap completely.

18. The EL luminous system according to claim 1, having a single-layer form.

19. The EL luminous system according to claim 1, having a multi-layer form.

20. The EL luminous system according to claim 3, wherein immediately adjacent electrodes of immediately adjacent EL elements form a single electrode.

21. The EL luminous system according to claim 1, wherein at least one of the at least two flat electrodes is largely transparent and at least one of the two electrodes has a graphically configured contour.

22. The EL luminous system according to claim 1, wherein the EL layer includes EL pigments distributed largely homogeneously in a polymeric binder matrix and/or the polymeric binder matrix has insulating properties.

23. The EL luminous system according to claim 1, wherein the at least one EL element is largely transparent and/or translucent.

24. The EL luminous system according to claim 1, further comprising at least one graphical layer.

25. The EL luminous system according to claim 24, comprising 2, 3, or 4 graphical layers.

26. The EL luminous system according to claim 24, wherein the at least one graphical layer includes one or more of masking, opaque, glazing, translucent, colour-filtering, colour-converting, semi-transparent and/or reflecting flat regions.

27. The EL luminous system according to claim 26, comprising at least two EL elements, the EL layers of each EL element including EL pigments, with the EL pigments of different EL layers having different emission wavelengths.

28. The EL luminous system according to claim 27, wherein at least one of the EL layers contains a polymeric binder matrix and/or added colour-converting substances in terms of a Stokes displacement by a few 10 to approximately 100 nm.

29. The EL luminous system according claim 28, wherein at least one of the EL pigments is configured pointwise.

30. The EL luminous system according to claim 29, wherein individual EL pigment points form geometrically exact shapes or randomly graphically configured shapes.

31. EL luminous system according to claim 29, wherein spaces between individual EL pigment points are filled with a transparent binder matrix having a low relative dielectric constant as compared with a relative dielectric constant of a layer formed by the EL pigment.

32. A process for the production of a flat EL luminous system having at least one layer according to claim 1 by means of screen printing and/or lamination.
